(19) United States
(12) Patent Application Publication
(10) Pub. No.: US 2026/0184441 A1
(43) Pub. Date: Jul. 2, 2026

(54) Reusable Launch Vehicle with Auxiliary Propellant Tanks for Non-Ascent Burns

(71) Applicant: Blue Origin, LLC, Kent, WA (US)

(72) Inventors: Adam M. WUERL, Seattle, WA (US); Gary GRAYSON, Maple Valley, WA (US); David DEGENHARDT, Seattle, WA (US)

(21) Appl. No.: 18/979,439

(22) Filed: Dec. 12, 2024

Related U.S. Application Data
(60) Provisional application No. 63/609,806, filed on Dec. 13, 2023.

(51) Int. Cl. B64G 1/00; F02K 9/42; F02K 9/60; F02K 9/94

(52) U.S. Cl. CPC B64G 1/006; F02K 9/425; F02K 9/605; F02K 9/94

(57) ABSTRACT

A reusable launch vehicle comprising auxiliary tanks for non-ascent burns, such as orbital maneuver burns, reorientation burns, deorbit burns, or landing burns, and/or power generation. The auxiliary tanks may provide propellants for an orbital maneuvering system, an orbital reaction control system, a reentry reaction control system, and/or a power generation system. The tanks are configured to maintain cryogenic properties of auxiliary fuel and auxiliary oxidizer for the duration of the mission. An auxiliary fuel tank, a main fuel tank, an auxiliary oxidizer tank, and a main oxidizer tank may have various relative positions with respect to each other within the launch vehicle. The auxiliary fuel tank and auxiliary oxidizer tank may comprise insulation to further insulate the cryogenic fluids.

### FIELD

This disclosure relates to launch vehicles, in particular to systems and methods for auxiliary propellant tanks for reusable launch vehicles.

### DESCRIPTION OF THE RELATED TECHNOLOGY

Traditional launch vehicles comprise one main fuel tank and one main oxidizer tank for storing all fuel and oxidizer comprised within the launch vehicle. The drawbacks of these traditional launch vehicles include their susceptibility to heat leakage into these tanks, which can boil-off usable propellants, and the sloshing of propellant in mostly empty tanks, which can lead to ullage collapse or difficulty in acquiring liquid propellants at the tank outlets. Boil-off and liquid acquisition difficulty renders propellant unusable and ullage collapse requires tank recondition that decreases performance. These problems are especially acute for reusable launch vehicles, which may have multiple uses for propellants after reaching orbit. Accordingly, improvements to traditional launch vehicles are desirable to increase the longevity and availability of propellant.

### SUMMARY

The embodiments disclosed herein each have several aspects no single one of which is solely responsible for the disclosure's desirable attributes. Without limiting the scope of this disclosure, its more prominent features will now be briefly discussed. After considering this discussion, and particularly after reading the section entitled “Detailed Description” one will understand how the features of the embodiments described herein provide advantages to reusable launch vehicles.

Systems and methods are described herein for use of auxiliary propellant tanks in reusable launch vehicles. The systems and methods mitigate boil off of rocket propellants. Cryogenic fuel and cryogenic oxidizers are stored in separate, small, and well-insulated auxiliary tanks packaged in areas not exposed to a free-stream during ascent. The auxiliary fuel and oxidizer are used for auxiliary purposes, such as orbit circularization, propellant settling, on-orbit maneuvering, attitude control, power and heat generation, tank pressurization, deorbit, and landing.

In one aspect of the systems and methods disclosed herein, a reusable launch vehicle is described having at least two separate auxiliary tanks for storing auxiliary cryogenic fuel and auxiliary cryogenic oxidizer, respectively. The auxiliary tanks are small compared to the main tanks and located within the body of the launch vehicle, which enables them to be better insulated to further maintain the cryogenic properties of the contents of the auxiliary tanks. The additional insulation may be insulation that would burn up or otherwise be removed or destroyed if exposed to the environment during launch or reentry rendering the insulation launch incompatible in traditional launch vehicles. The auxiliary tanks are in fluid communication with one or more of the launch vehicle's main, orbital maneuvering, and reaction control system engines, systems that use auxiliary tank fluids to generate electrical power and heat, supply mechanical power, and pressurize and condition tanks. The placement, size, and insulating material of the auxiliary tanks advantageously preserve the temperature and pressure of the cryogenic fluids for continual use for the duration of the mission. The auxiliary tanks have other advantages, such as slosh mitigation, liquid acquisition, etc. as further described, and which apply to cryogenic propellants but are also advantageous for embodiments where the propellants are not cryogenic.

In one aspect of the system and methods disclosed herein, a reusable upper stage rocket is described. The rocket includes a rocket body, main fuel tank, a main oxidizer tank, an auxiliary fuel tank, and an auxiliary oxidizer tank. The rocket body extends from an aft end to a forward end, the forward end comprising a payload and the aft end comprising a main engine. The main fuel tank is located within the rocket body and stores liquid hydrogen. The main oxidizer tank is located within the rocket body and stores liquid oxygen. The main fuel tank and the main oxidizer tank are in fluid communication with the main engine and are configured to provide the respective liquid hydrogen and liquid oxygen to the main engine to produce a main ascent burn. The auxiliary fuel tank is located within the rocket body and stores additional liquid hydrogen. The auxiliary fuel tank is fluidly separated from the main fuel tank and the main oxidizer tank and comprises insulation configured to thermally insulate the additional liquid hydrogen. The auxiliary oxidizer tank is located within the rocket body and stores additional liquid oxygen. The auxiliary oxidizer tank is fluidly separated from the main fuel tank and the main oxidizer tank and comprises insulation configured to thermally insulate the additional liquid oxygen. The auxiliary fuel tank and the auxiliary oxidizer tank are not configured to provide the respective additional liquid hydrogen and additional liquid oxygen to the main engine to produce the main ascent burn.

The above and other aspects have various embodiments. For example, in some embodiments, the auxiliary fuel tank and the auxiliary oxidizer tank are not exposed to a free-stream during ascent of the rocket. In some embodiments, the rocket further includes an orbital maneuvering system engine, where the auxiliary fuel tank and the auxiliary oxidizer tank are in fluid communication with the orbital maneuvering system engine and are configured to provide the respective additional liquid hydrogen and additional liquid oxygen to the orbital maneuvering system engine to produce an orbital maneuver burn. In some embodiments, the rocket further includes a reaction control system thruster, where the auxiliary fuel tank and the auxiliary oxidizer tank are in fluid communication with the reaction control system thruster and are configured to provide the respective additional liquid hydrogen and additional liquid oxygen to the reaction control system thruster to produce a reorientation burn. In some embodiments, the auxiliary fuel tank and the auxiliary oxidizer tank are in fluid communication with the main engine and are configured to provide the respective additional liquid hydrogen and additional liquid oxygen to the main engine to produce a landing burn. In some embodiments, the auxiliary fuel tank and the auxiliary oxidizer tank are in fluid communication with the main engine and are configured to provide the respective additional liquid hydrogen and/or additional liquid oxygen to the main engine as coolant to chill-in the main engine. In some embodiments, the auxiliary fuel tank and/or the auxiliary oxidizer tank are configured to insulate from heat that leaks into the main oxidizer tank or the main fuel tank to maintain the liquid oxygen or liquid hydrogen respectively at cryogenic temperatures. In some embodiments, the rocket further includes hydrogen-oxygen fuel cells. In some embodiments, the auxiliary fuel tank and the auxiliary oxidizer tank are in fluid communication with the hydrogen-oxygen fuel cells and are configured to provide the respective additional liquid hydrogen and/or additional liquid oxygen as reactants in the hydrogen-oxygen fuel cells for generating electrical power. In some embodiments, the auxiliary fuel tank and auxiliary oxidizer tank allocate fuel and oxidizer dynamically between auxiliary systems. In some embodiments, the rocket further comprises a heat exchanger, and the auxiliary fuel tank and the auxiliary oxidizer tank are in fluid communication with the heat exchanger, with the heat exchanger configured to convert the additional liquid hydrogen or additional liquid oxygen into gaseous form to drive a secondary device. In some embodiments, the secondary device comprises one or more of a valve, a turbine, a rotating device, or a pneumatic device. In some embodiments, the auxiliary fuel tank and the auxiliary oxidizer tank allocate fuel and oxidizer dynamically between auxiliary systems. In some embodiments, the rocket further includes an annular support structure disposed on a forward end of the main oxidizer tank and supporting the auxiliary oxidizer tank forward of the main oxidizer tank. In some embodiments, the main oxidizer tank is within the main fuel tank. In some embodiments, the main oxidizer tank is in an aft portion of the main fuel tank. In some embodiments, the auxiliary fuel tank is forward of and supported by the main oxidizer tank. In some embodiments, the main oxidizer tank is forward of the main fuel tank. In some embodiments, the auxiliary oxidizer tank is forward of and supported by the main oxidizer tank.

In another aspect, a launch vehicle is described that includes a reusable first stage rocket and a reusable upper stage rocket. The reusable upper stage rocket is supported forward of the reusable first stage rocket. The reusable upper stage rocket comprises a rocket body, a main fuel tank, a main oxidizer tank, an auxiliary fuel tank, and an auxiliary oxidizer tank. The rocket body extends from an aft end to a forward end, with the forward end having a payload and the aft end comprising a main engine. The main fuel tank is located within the rocket body and stores liquid hydrogen. The main oxidizer tank is located within the rocket body forward of the main fuel tank and stores liquid oxygen. The main fuel tank and the main oxidizer tank are in fluid communication with the main engine and are configured to provide the respective liquid hydrogen and liquid oxygen to the main engine to produce a main ascent burn. The auxiliary fuel tank is located within the rocket body and stores additional liquid hydrogen, with the auxiliary fuel tank fluidly separated from the main fuel tank and the main oxidizer tank and comprising insulation configured to thermally insulate the additional liquid hydrogen. The auxiliary oxidizer tank is located within the rocket body and stores additional liquid oxygen, with the auxiliary oxidizer tank fluidly separated from the main fuel tank and the main oxidizer tank and comprising insulation configured to thermally insulate the additional liquid oxygen. The auxiliary fuel tank and the auxiliary oxidizer tank are not configured to provide the respective additional liquid hydrogen and additional liquid oxygen to the main engine to produce the main ascent burn.

The above and other aspects have various embodiments. For example, in some embodiments, the auxiliary fuel tank and the auxiliary oxidizer tank are not exposed to a free-stream during ascent of the launch vehicle. In some embodiments, the reusable upper stage rocket further includes an orbital maneuvering system engine, where the auxiliary fuel tank and the auxiliary oxidizer tank are in fluid communication with the orbital maneuvering system engine and are configured to provide the respective additional liquid hydrogen and additional liquid oxygen to the orbital maneuvering system engine to produce an orbital maneuver burn. In some embodiments, the reusable upper stage rocket further includes a reaction control system thruster, where the auxiliary fuel tank and the auxiliary oxidizer tank are in fluid communication with the reaction control system thruster and are configured to provide the respective additional liquid hydrogen and additional liquid oxygen to the reaction control system thruster to produce a reorientation burn. In some embodiments, the reusable upper stage rocket, the auxiliary fuel tank, and the auxiliary oxidizer tank are in fluid communication with the main engine and are configured to provide the respective additional liquid hydrogen and additional liquid oxygen to the main engine to produce a landing burn.

In another aspect, a method of supplying auxiliary fuel and auxiliary oxidizer to a reusable upper stage rocket for non-ascent purposes is described. The method comprises storing the auxiliary fuel and auxiliary oxidizer in respective separate auxiliary tanks that are fluidly separated from a main fuel tank and from a main oxidizer tank, causing a flow of the auxiliary fuel and/or the auxiliary oxidizer to a component of the reusable upper stage rocket, and operating the component using the auxiliary fuel and/or the auxiliary oxidizer for a purpose other than an ascent burn of the upper stage rocket.

The above and other aspects have various embodiments. For example, in some embodiments, operating the component comprises producing an orbital maneuver burn, producing a reorientation burn, or producing a landing burn. In some embodiments, the method further comprises performing an orbital maneuver with the reusable upper stage rocket, reorienting the attitude of the reusable upper stage rocket, or landing the reusable upper stage rocket.

### BRIEF DESCRIPTION OF THE DRAWINGS

The foregoing and other figures of the disclosure will become more fully apparent from the following description and appended claims, taken in conjunction with the accompanying drawings.

FIG. 1 is a side elevation view of an embodiment of a launch vehicle having a reusable first stage rocket and reusable upper stage rocket.

FIG. 2A is a side cross sectional view of the internal components of an embodiment of a reusable upper stage rocket that may be used with the launch vehicle of FIG. 1.

FIG. 2B is a bottom view of the reusable upper stage rocket of FIG. 2A.

FIG. 2C is a side cross sectional view of another embodiment of the reusable upper stage rocket of FIG. 2A.

FIGS. 2D-2L are side cross sectional views of the internal components of various other embodiments of a reusable upper stage rocket that may be used with the launch vehicle of FIG. 1.

FIG. 3 is a schematic illustration of an embodiment of a layout of fuel systems that may be used with the reusable upper stage rocket of FIG. 2A.

FIG. 4 is a flow chart showing an embodiment of a method of using auxiliary tanks for non-ascent burns in a reusable launch vehicle.

### DETAILED DESCRIPTION

In the following detailed description, reference is made to the accompanying drawings. In the drawings, similar symbols typically identify similar components, unless context dictates otherwise. Thus, in some embodiments, part numbers may be used for similar components in multiple figures, or part numbers may vary from figure to figure. The illustrative embodiments described herein are not meant to be limiting. Other embodiments may be utilized, and other changes may be made, without departing from the spirit or scope of the subject matter presented. It will be readily understood that the aspects of the present disclosure and illustrated in the figures, can be arranged, substituted, combined, and designed in a wide variety of different configurations by a person of ordinary skill in the art, all of which are made part of this disclosure.

Reference in the specification to “one embodiment,” “an embodiment”, or “in some embodiments” means that a particular feature, structure, or characteristic described in connection with the embodiment is included in at least one embodiment of the disclosure. Moreover, the appearance of these or similar phrases throughout the specification does not necessarily mean that these phrases all refer to the same embodiment, nor are separate or alternative embodiments necessarily mutually exclusive. Various features are described herein which may be exhibited by some embodiments and not by others. Similarly, various requirements are described which may be requirements for some embodiments but may not be requirements for other embodiments.

Reference in the specification to directional terms may be used for purposes of describing the orientation and positioning of components of a launch vehicle described herein. Accordingly, the following definitions will be used: a “midline” means a reference vertical line down the longitudinal or central axis of the launch vehicle; “medial” means toward the midline or central axis of the launch vehicle; “lateral” means away from the midline or central axis of the launch vehicle; “anterior” or “ventral” means the front of the launch vehicle; “posterior” or “dorsal” means the back of the launch vehicle; “proximal” means towards or near a particular reference point; and “distal” means away or far from a particular reference point. Furthermore, “forward” means at, near, or toward the bow or nose of a launch vehicle while “aft” means at, near, or toward the stern or tail of a launch vehicle. Accordingly, a substantially cylindrical launch vehicle existing in three dimensions may comprise a right side, a left side, an anterior side, a posterior side, a forward side, and an aft side, wherein the right and left sides may be identified along an X-X axis divided by a midline along the Y-Y axis, wherein the anterior and posterior sides may be identified along a Z-Z axis separated by a midline along the Y-Y axis, and the forward and aft sides may be identified along a Y-Y axis separated by a midline along the X-X or Z-Z axes. Furthermore, the axes shown or described in this disclosure sharing a prefix such as “X”, “Y”, or “Z” are coplanar with other like axes and may be spaced intermittently along a shared axis. For example, two X-X axes denoted as Xₙ-Xₙ and Xₘ-Xₘ may be coplanar along an X-Y plane and spaced intermittently along a Y-Y axis.

Cryogenic fluids such as liquified hydrogen, liquified methane, and liquified oxygen are commonly used as rocket propellants in several propulsion systems during space travel. Cryogenic fluids are gases at naturally occurring, typical atmospheric temperatures and pressures but can change phase to a liquid after dropping below their boiling point at extremely low temperatures (e.g., below −238° Fahrenheit). Cryogenic fluids can thus evaporate or “boil off” when the temperature of the cryogenic fluid passes above its boiling point. Cryogenic fluids are preferred as a rocket propellant because these fluids provide higher performance compared to non-cryogenic propellants (e.g., kerosene) and liquefied propellants are higher density than when in their gaseous phase and can thus be stored in smaller and more mass-efficient tanks. When the cryogenic propellants boil off they are no longer available for use by systems designed to operate on liquid propellants. Some auxiliary systems can operate on gaseous propellants but these would need to be stored at low density in impractically large and heavy gas bottles. Accordingly, it is desirable to design a launch vehicle configured to store cryogenic fluids below their boiling point for the duration of the mission.

Traditionally, launch vehicles comprise a main fuel and a main oxidizer tank for storing all fuel and oxidizer comprised within the particular launch vehicle. These main tanks are susceptible to heat leaks into the tanks over a period of several days in orbit due to inadequate launch-compatible insulation, causing the cryogenic fuel to boil off. This renders the fuel unusable for auxiliary purposes after the main ascent burn, such as for orbit circularization, propellant settling, on-orbit maneuvering, attitude control, power and heat generation, tank pressurization, deorbit, and landing. Accordingly, it is desirable to design a launch vehicle with enhanced insulation and a novel configuration to prevent heat leaks into the main tanks containing the cryogenic fluids.

Additionally, traditional launch vehicles were not reusable and did not require significant on-orbit life or maneuvering, deorbit, or landing. Similarly, power generation was modest and designed for short-duration missions which could be sufficiently powered via batteries. Accordingly, most launch vehicles only comprise a pair of large main tanks to contain fuel and oxidizer. The launch sequence itself consumes most of the fuel and oxidizer contained within the respective main propellant tanks such that the main tanks are mostly empty at the end of the main ascent burn. Accordingly, the main propellant tanks provide a large volume for the remaining cryogenic fuel and cryogenic oxidizer to slosh around in, rendering it difficult to acquire and feed the remaining fuel and oxidizer to auxiliary systems after launch. The issue is amplified in micro-gravity. Furthermore, the sloshing movement of the cryogenic fuel and cryogenic oxidizer encourages additional heat transfer between the cryogenic fluids and the ullage gas, thereby leading to ullage collapse requiring tank conditioning and repressurization to resolve and further increasing the rocket's fuel consumption. Slosh also increases the heat transfer from warm tank walls to cryogenic propellant, which increases boil-off. Accordingly, it is desirable to design a launch vehicle having a fuel tank defining a volume configured to minimize the sloshing of cryogenic fuel and cryogenic oxidizer.

A reusable launch vehicle according to the present disclosure is described comprising auxiliary tanks for non-ascent burns, such as burns for orbit circularization, propellant settling, on-orbit maneuvering, attitude control, power and heat generation, tank pressurization, deorbit, and landing. The auxiliary tanks are configured to maintain cryogenic properties of auxiliary fuel and auxiliary oxidizer for the duration of the mission. In some embodiments, the auxiliary fuel tank may be positioned within a main fuel tank to shield the auxiliary fuel tank from a free-stream during ascent. Additionally and/or alternatively, in some embodiments, the auxiliary oxidizer tank may be located within the main oxidizer tank to shield the auxiliary oxidizer tank from a free-stream during ascent. Additionally and/or alternatively, the auxiliary fuel tank and/or the auxiliary oxidizer tank may be located within the body of the launch vehicle and positioned exterior and forward of the main oxidizer tank. Additionally and/or alternatively, the auxiliary oxidizer tank may be located forward of the main oxidizer tank, aft of the main oxidizer tank, or internal to the main oxidizer tank. Additionally and/or alternatively, the auxiliary fuel tank may be located outside of the main fuel tank but still protected from the free-stream. Additionally and/or alternatively, the main oxidizer tank may be aft of the main fuel tank and/or in an aft location of the rocket. Additionally and/or alternatively, the auxiliary oxidizer tank may be aft of the main fuel tank and/or in an aft location of the rocket. Additionally and/or alternatively, the auxiliary fuel tank and/or the auxiliary oxidizer tank may be located within the body of the launch vehicle and positioned exterior and forward of the main fuel tank. Additionally and/or alternatively, the main oxidizer tank, the auxiliary fuel tank and/or the auxiliary oxidizer tank may be located within the body of the launch vehicle and exterior of the main fuel tank. In any embodiments, the auxiliary fuel tank and the auxiliary oxidizer tank can be protected from the free-stream. The auxiliary fuel tank and auxiliary oxidizer tank may comprise insulation to further insulate the cryogenic fluids. The reusable vehicle may be an upper stage rocket of a launch system, although the features described herein may be used with other reusable vehicles, such as first stage rockets. There may be one or more of the auxiliary fuel tank and/or one or more of the auxiliary oxidizer tank.

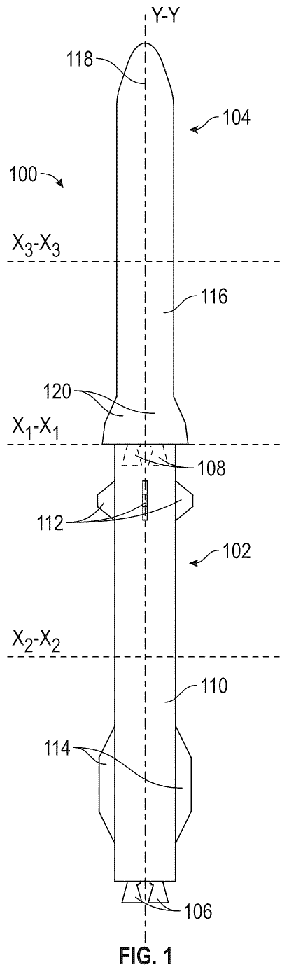

FIG. 1 illustrates an embodiment of a multi-stage launch vehicle 100 comprising a first stage 102 such as a first stage rocket and an upper stage 104 such as a second or upper stage rocket. The first stage 102 comprises one or more engines 106 and the upper stage 104 further comprises one or more engines 108 (the engines 108 are inside the multi-stage launch vehicle 100 and thus shown in dashed line in FIG. 1). The multi-stage launch vehicle 100, and corresponding stages 102, 104 may each comprise a respective aft end and forward end, where the aft end corresponds to the tail where the engines 106, 108 are located and wherein the forward end corresponds to the nose located at the end opposite the aft end. For example, the X₁-X₁ axis may divide the aft and forward ends of the multi-stage launch vehicle 100, while the X₂-X₂ and X₃-X₃ axes may divide the aft and forward ends of the respective stages 102, 104. In some embodiments, the aft end of the upper stage 104 may be configured to couple to the forward end of the first stage 102. The multi-stage launch vehicle 100 may comprise any number of stages between the first stage 102 and the upper stage 104.

The multi-stage launch vehicle 100 is configured to successively activate the stages 102, 104 beginning with the first stage 102 and culminating with the upper stage 104. The multi-stage launch vehicle 100 may be configured to jettison stages. In response to jettisoning expended stages, the multi-stage launch vehicle 100 may activate successive remaining stages. In some embodiments, the stages 102, 104 may be reusable. In such embodiments, the jettisoned reusable stages may comprise an auxiliary fuel reserve and landing apparatus for landing the jettisoned reusable stage.

The multi-stage launch vehicle 100 may comprise any desired number of stages for optimizing a launch according to mission parameters such as the distance/duration of the mission and balancing weight and thrust capabilities. For example, in some embodiments, the multi-stage launch vehicle 100 may comprise three, four or five stages. The stages 102, 104 of the multi-stage launch vehicle 100 may have rockets configured in parallel or serially. For instance, the multi-stage launch vehicle 100 may have multiple rockets configured in parallel when two or more stages are attached next to each other. By comparison, the multi-stage launch vehicle 100 may be serially configured when two or more stages are stacked on top of one another, as shown in FIG. 1. In such embodiments, the first stage 102 may form a base and may be the largest stage of the multi-stage launch vehicle 100 with each subsequent stage decreasing in size and thrust capability.

The first stage 102 may comprise a thin-walled cylindrical shell defining a rocket body 110. The rocket body 110 may include an outer wall having a thickness that defines a diameter and length of the first stage 102. The rocket body 110 defines one or more internal cavities. In some embodiments, the thickness of the rocket body 110, for example of a sidewall of the rocket body 110, may be about 0.050 inches or from about 0.020 inches to about 0.150 inches, the diameter may be about 23 feet (ft) or from about 15 ft to about 30 ft, and/or the length may be about 190 feet or from about 100 ft to about 250 ft. The one or more internal cavities may further comprise one or more storage tanks for housing propellant, fuel, and/or oxidizer as further described herein, and one or more engines 106 in fluid communication with the one or more storage tanks. The forward end of the first stage 102 may comprise a cavity sized to receive the one or more engines 108 of the upper stage 104 and may be configured to engage with and couple to the aft end of the upper stage 104.

In some embodiments, the first stage 102 may further comprise a plurality of fins 112. The fins 112 may extend radially from the rocket body 110, oriented in parallel with the length of the first stage 102, and may be positioned equidistantly around the rocket body 110 for providing stability, controlling direction, and providing attitude adjustment during descent and landing. For example, the first stage 102 may have four fins 112 positioned near the forward end of the first stage 102.

In some embodiments, the first stage 102 may further comprise two or more wing-like strakes 114. The two or more strakes 114 may extend radially from the rocket body 110, oriented in parallel with the length of the first stage 102, and may be positioned equidistantly around the rocket body 110 for providing lift and cross-range for a reusable first stage 102 as it returns to earth. The two or more strakes 114 may be positioned near the aft end of the first stage 102.

The upper stage 104 may similarly be a thin-walled cylindrical shell defining a rocket body 116 comprising an outer wall having a thickness that defines a diameter and length of the upper stage 104. The rocket body 116 defines one or more internal cavities. In some embodiments, the thickness may be about 0.050 inches or from about 0.020 inches to about 0.150 inches, the diameter may be about 23 ft or from about 15 ft to about 30 ft, and/or the length may be about 100 ft or from about 60 ft to about 160 ft. The one or more internal cavities of the upper stage 104 may further comprise one or more storage tanks for housing propellant such as fuel and/or oxidizer as further described, and one or more engines 108 in fluid communication with the one or more storage tanks. In some embodiments, the forward end of the upper stage 104 may taper to a point defining a nose cone 118, as shown in FIG. 1. In such embodiments, the forward end of the upper stage 104 is the forward end of the multi-stage launch vehicle 100. Furthermore, in some embodiments, the forward end of the upper stage 104 may be a fairing covering a payload. The upper stage 104 may further comprise one or more fins 120 extending outwardly from the aft end of the rocket body 116 for minimizing drag, providing stability, controlling direction, and in some embodiments creating lift.

The engines 106, 108 may be positioned at the aft end of each respective stage of the multi-stage launch vehicle 100. The engines 106, 108 may be any engine capable of providing adequate thrust to lift the combined mass of the remaining portions of the multi-stage launch vehicle 100. For example, in some embodiments, the engines 106, 108 may be selected from the following engines: a peroxide fueled rocket engine; a kerosene fueled rocket engine; a methane fueled rocket engine; a liquefied natural gas fueled rocket engine, such as a BE-4 engine; or a liquefied hydrogen fueled rocket engine, such as a BE-3PM engine or a BE-3U engine. Accordingly, the engines 106, 108 may be further selected based on the propellant stored on board. Furthermore, the number, layout, or fuel type of the engines 106, 108 may differ and be uniquely selected based on mission parameters.

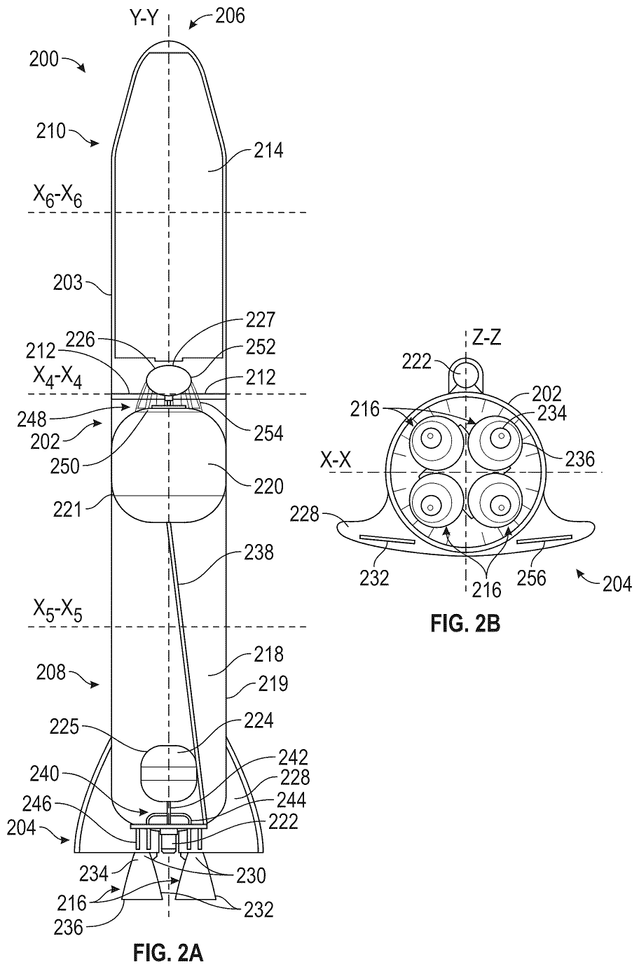

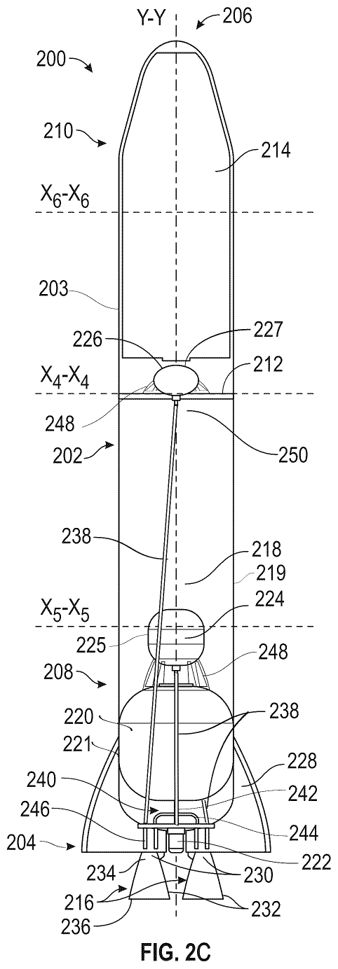

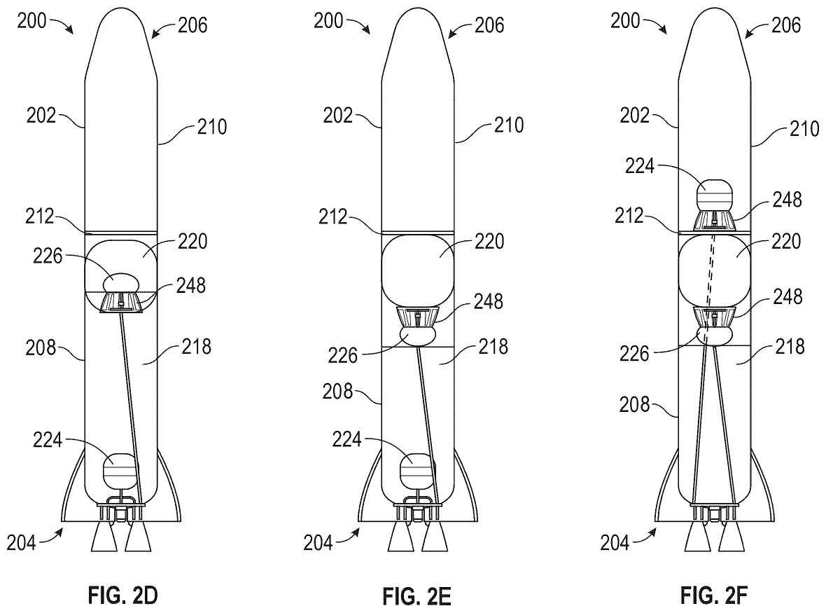

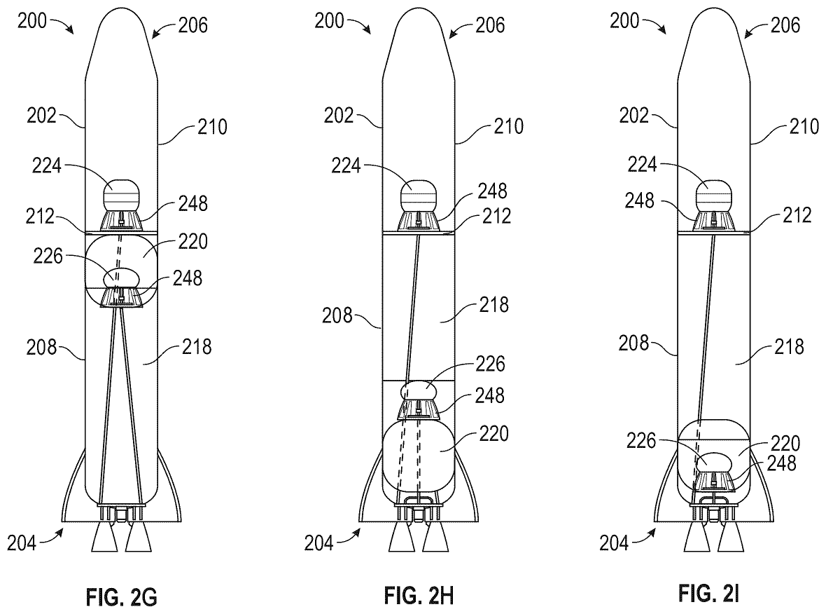

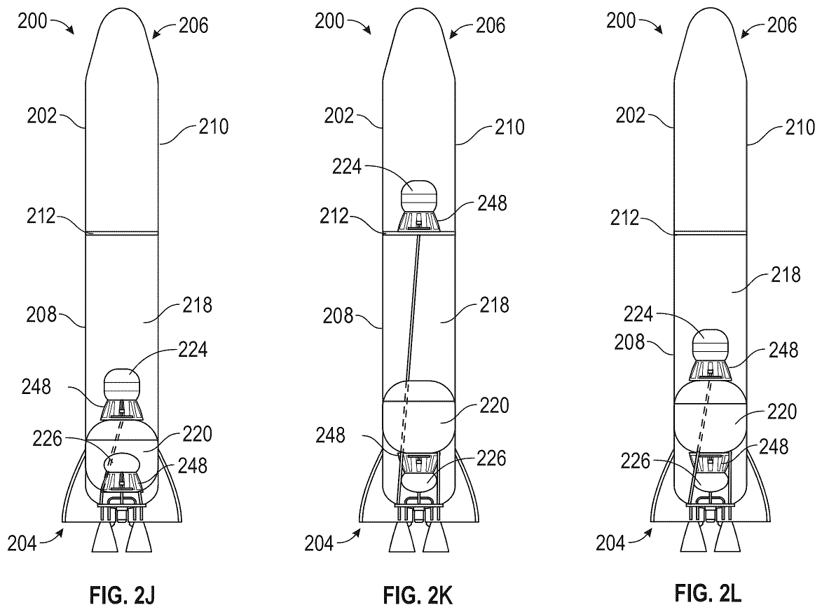

FIGS. 2A and 2B illustrate a reusable launch vehicle 200 comprising a rocket body 202 extending from an aft end 204 to a forward end 206 divided by an X₄-X₄ axis. In some embodiments, the reusable launch vehicle 200 may be a reusable upper stage rocket such as the upper stage 104 shown in and described with respect to FIG. 1. In such embodiments, the X₄-X₄ axis shown in FIG. 2A may be the same as the X₃-X₃ axis shown in FIG. 1. Furthermore, in some embodiments, the reusable launch vehicle 200 may further comprise an aft chamber 208 and a forward chamber 210 wherein the aft chamber 208 and forward chamber 210 define cavities separated by a payload adapter 212. The aft and forward chambers 208, 210 may be generally on respective sides of the X₄-X₄ axis and each have aft and forward ends further divided by X₅-X₅ and X₆-X₆ axes, respectively, as shown in FIG. 2A. The reusable launch vehicle 200 may further comprise, located within the one or more cavities defined within the rocket body 202, a payload 214, one or more main engines 216, a main fuel tank 218, a main oxidizer tank 220, an orbital maneuvering system engine 222, an auxiliary fuel tank 224, and an auxiliary oxidizer tank 226.

The reusable launch vehicle 200 may further comprise additional systems and hardware for operating the reusable launch vehicle 200 in orbit and/or for landing the reusable launch vehicle 200. For example, the reusable launch vehicle 200 may further comprise a reaction control system. The reusable launch vehicle 200 may comprise one or more fuel cells in fluid communication with the auxiliary fuel tank 224 and auxiliary oxidizer tank 226 for generating electrical power. In some embodiments, the fuel cells are hydrogen-oxygen fuel cells in fluid communication, where the auxiliary fuel tank 224 comprises hydrogen and the auxiliary oxidizer tank 226 comprises oxygen. Additionally, the reusable launch vehicle 200 may comprise a heat exchanger for converting cryogenic fluids into a gaseous form for driving a secondary device further comprising a turbine, a rotating device, and a pneumatic device.

The aft chamber 208 may be positioned on the aft side of the payload adapter 212 of the reusable launch vehicle 200. The body of the aft chamber 208 may be substantially cylindrical. In some embodiments, the aft chamber 208 may define a cavity forming or including a main fuel tank 218 primarily occupying a section aft of the oxidizer tank 220. A forward end of the main fuel tank 218 may surround a lower portion of the oxidizer tank 220. The main oxidizer tank 220 may be located within the forward end of the aft chamber 208. The aft chamber 208 may further comprise the auxiliary fuel tank 224, the auxiliary oxidizer tank 226, and one or more downcomers 238 running through the main fuel tank 218, as further described.

The forward chamber 210 may be positioned on the forward side of the payload adapter 212 of the reusable launch vehicle 200. The body of the forward chamber 210 may include an aft end sharing the same geometric dimensions as the forward end of the aft chamber 208 and taper to a rounded point at the forward end 206. In some embodiments, the aft end of the forward chamber 210 may couple to the forward end of the aft chamber 208. Furthermore, in some embodiments, the forward chamber 210 may be removably coupled to the aft chamber 208. In some embodiments, the forward chamber 210 may be a fairing comprising the payload 214. In such embodiments, the forward chamber 210 may be configured to protect the payload 214 against impact of dynamic pressure and aerodynamic heating during launch. In some embodiments, the body of the forward chamber 210 may be a clamshell fairing configured to break apart in space and jettisoned for releasing the payload 214 into orbit. In some embodiments, the body of the forward chamber 210 may be an airtight capsule defining a cockpit.

The payload adapter 212 may define a boundary between the aft chamber 208 and the forward chamber 210 comprising one or more barriers for the forwardmost end of the aft chamber 208 and the aftmost end of the forward chamber 210. Furthermore, the payload adapter 212 may be configured to provide an airtight seal for both chambers 208, 210 to prevent the contents of the two chambers 208, 210 from leaking. Furthermore, the payload adapter 212 may couple the aft chamber 208 to the forward chamber 210. In some embodiments, the payload adapter 212 may comprise one or more mechanical means for coupling the aft chamber 208 to the forward chamber 210. The payload 214 may be carried by the reusable launch vehicle 200 and may include cargo, passengers, another space vehicle comprising passengers, or fuel for other launch vehicles.

As shown in FIGS. 2A and 2B, the one or more main engines 216 may be identical and equidistantly positioned about the center of the aft end 204 of the reusable launch vehicle 200. The one or more main engines 216 may be in fluid communication with the main fuel tank 218 and main oxidizer tank 220 via one or more downcomers 238 to provide respective fuel and oxidizer to the one or more main engines 216 for producing a main ascent burn.

In some embodiments, the one or more main engines 216 may each further comprise a thrust chamber assembly 230 and a nozzle assembly 232. There may be one or more pumps for providing oxidizer and fuel to the main engines 216. The thrust chamber assembly 230 may be physically coupled to the forward end of the nozzle assembly 232 and in fluid communication with the oxidizer pump and the fuel pump. In some embodiments, the nozzle assembly 232 may form a bell or conical shape, where the diameter of the inlet 234 located at the forward end of the nozzle assembly 232 is greater than the diameter of the outlet 236 located at the aft end of the nozzle assembly 232. In some embodiments, the nozzle assemblies 230 of the one or more main engines 216 may be movable, such as with thrust vectoring, to control a direction of flight such as during landing. In some embodiments, the thrust chamber assembly further comprises a combustion chamber positioned adjacent to the inlet of the nozzle assembly. Accordingly, the fuel and oxidizer may be mixed and ignited in the thrust chamber assembly such that the nozzle assembly provides an exhaust for the resulting combustion.

In some embodiments, the one or more main engines 216 may undergo one or more expander cycles wherein the fuel pump may direct the cryogenic fuel around the periphery of the thrust chamber assembly and/or nozzle assembly before entering the thrust chamber assembly for combustion. Additionally or alternatively, the oxidizer pump may similarly direct the cryogenic oxidizer around the periphery of the thrust chamber assembly and/or nozzle assembly before entering the thrust chamber assembly for combustion. The one or more expander cycles advantageously cool the one or more main engine's 216 combustion chamber. In some embodiments, the cryogenic fuel and cryogenic oxidizer may be sufficiently heated thereby changing the phase of the cryogenic fuel and cryogenic oxidizer into a gas. The resulting gases may be advantageously configured to power a turbine within the thrust chamber assembly driving the one or more main engine's 216 fuel and oxidizer pumps before being injected into the combustion chamber and burned.

The one or more main engines 216 may be any engine configured to provide adequate thrust based on mission parameters including the type of propellant used and mass of the reusable launch vehicle 200 and payload 214.

The main fuel tank 218 may be located within the rocket body 202 and may extend between the aft end 204 and the main oxidizer tank 220. In some embodiments, the main fuel tank 218 may be fully integrated within the cavity defined by aft chamber 208. The main fuel tank 218 may be formed from a launch-compatible material. In some embodiments, the main fuel tank 218 may be formed from aluminum. In other embodiments, the main fuel tank 218 may be formed from other launch-compatible materials including composites, titanium, and/or stainless steel, and may further comprise an external launch-compatible insulation 219. The insulation 219 may cover all or substantially all or a majority of an outer structural body that forms the main fuel tank 218. In some embodiments, forming the main fuel tank 218 from stainless steel may advantageously provide higher allowable temperature which can reduce the mass of the thermal protection system and lower thermal conductivity and diffusivity, which when coupled with thinner walls reduces structural heat leak into the main fuel tank 218. In some embodiments, the main fuel tank 218 may be physically coupled to and in fluid communication with one or more downcomers 238 for providing fuel to the one or more main engines 216 for producing a main ascent burn.

The main fuel tank 218 may be configured to store fuel to be used as a propellant for providing thrust to the reusable launch vehicle 200 during the main ascent burn. Additionally, the main fuel tank 218 may store fuel to provide to other vehicles during a tanker mission. In some embodiments, main fuel tank 218 may be initially pressurized prior to launch using helium provided by ground infrastructure. During engine burn, the main fuel tank 218 may be autogenously pressurized by the one or more main engines 216. In some embodiments, the main fuel tank 218 may not be repressurized after either reaching orbit or completing a tanker mission.

The main fuel tank 218 may store any desirable fuel including kerosene, alcohol, hydrazine, liquified methane/natural gas, and/or liquified hydrogen. In some embodiments, liquified hydrogen may be preferred as a primary fuel due to its versatile uses. For instance, liquified hydrogen may be advantageously used as: a propellant for providing thrust to the reusable launch vehicle 200; as a coolant to chill-in engines and intercept heat leaking into the main fuel tank 218 for maintaining cryogenic fluids at known and usable temperatures and pressures; and/or as a reactant in hydrogen-oxygen fuel cells for generating electrical power to the reusable launch vehicle 200. Liquefied hydrogen is particularly efficient as a coolant due to its high specific heat capacity and heat of vaporization. Additionally, hydrogen-oxygen fuel cells may have advantages over batteries or solar arrays in generating electrical power. Accordingly, a liquified hydrogen fuel can satisfy several needs of a reusable launch vehicle 200 and can reduce the number of containers and systems.

The main oxidizer tank 220 may be located at or near the forward end of the aft chamber 208 within the rocket body 202 and forward or mostly forward of the main fuel tank 218. The main oxidizer tank 220 may be formed from several launch-compatible materials including titanium, stainless steel, and/or aluminum, and may further comprise an external launch-compatible insulation 221. The insulation 221 may cover all or substantially all or a majority of an outer structural body that forms the main oxidizer tank 220. In some embodiments, forming the main fuel tank 218 from stainless steel may be preferred due to stainless steel's higher allowable temperature which can reduce the mass of the thermal protection system and lower thermal conductivity and diffusivity. Additionally, the main oxidizer tank 220 may be physically coupled to and in fluid communication with one or more downcomers 238 configured to support the main oxidizer tank 220 and for providing oxidizer to the one or more main engines 216 for producing a main ascent burn. The one or more downcomers 238 may be a pipe, tube, conduit, or other similar device having an outer shell defining a lumen or inside volume of a tubular structure configured to transport fluids out of a storage tank such as the main or auxiliary oxidizer tanks 220, 226. In some embodiments, the one or more downcomers 238 transport the fluid downward toward the combustion chamber located at the aft end of the reusable launch vehicle 200.

The main oxidizer tank 220 may be configured to store an oxidizer to be used as a propellant for providing thrust to the reusable launch vehicle 200 during the main ascent burn. In some embodiments, the main oxidizer tank 220 may be initially pressurized prior to launch using helium provided by ground infrastructure. During engine burn, the main oxidizer tank 220 may be autogenously pressurized by the one or more main engines 216. In some embodiments, the main oxidizer tank 220 may not be repressurized after either reaching orbit or completing a tanker mission.

The main oxidizer tank 220 may store any desirable oxidizer including nitric acid, nitrogen tetroxide, liquified oxygen, and liquified fluorine. In some embodiments, liquified oxygen may be preferred as a primary oxidizer due to its advantageous use with liquified hydrogen. In particular, hydrogen combusts efficiently with oxygen and hydrogen-oxygen fuel cells are more efficient than batteries or solar arrays in generating electrical power.

The orbital maneuvering system may be a system configured to cause the reusable launch vehicle 200 to perform various orbital maneuvers according to mission requirements and parameters, including orbital injection after the one or more main engines 216 are cutoff, orbital corrections during flight, and a final deorbit burn for reentry. The orbital maneuvering system may comprise an orbital maneuvering system engine 222 in fluid communication with the auxiliary fuel tank 224 and the auxiliary oxidizer tank 226 for producing a non-ascent burn, such as an in-space maneuver burn. In some embodiments, the orbital maneuvering system may include one or more orbital maneuvering system engines 222 packaged in a pod located on the leeward side of the aft end 204. In some embodiments, the orbital maneuvering system engine 222 may be canted to align mid-way between the center-of-mass during orbit circularization and reentry.

The orbital maneuvering system engine 222 may be any engine configured to provide adequate thrust based on mission parameters including the type of propellant used and mass of the reusable launch vehicle 200 and remaining payload 214. In some embodiments, the orbital maneuvering system may include a plurality of orbital maneuvering system engines 222 to provide redundancy in orbital flight. Alternatively, the orbital maneuvering system may include a singular orbital maneuvering system engine 222 to conserve mass and optimize fuel consumption, as shown in FIGS. 2A and 2B.

The auxiliary fuel tank 224 may be configured to store additional and auxiliary fuel fluidly separate from the main fuel tank 218. The auxiliary fuel tank 224 may be coupled to and in fluid communication with one or more downcomers 238 configured to provide auxiliary fuel to a plurality of auxiliary systems. Such auxiliary systems may include: a heat exchanger for converting the cryogenic fuel into a gaseous form to power a secondary device; one or more fuel cells such as hydrogen-oxygen fuel cells for generating electrical power; and/or one or more reentry reaction control system thrusters, orbital reaction control thrusters, the orbital maneuvering system engine 222, or landing engines for providing ascent circularization, settling, on-orbit maneuvering, attitude control, deorbit, and landing by providing the auxiliary fuel to said systems. In some embodiments, the auxiliary fuel tank 224 may not be configured to provide the additional fuel therein to the one or more main engines 216 as propellant for producing the main ascent burn. Instead, in some embodiments, the auxiliary fuel may be exclusively used for non-ascent burns or non-burn uses. For instance, the auxiliary fuel tank 224 may be physically coupled to and in fluid communication with the one or more downcomers 238 for providing the auxiliary fuel to the one or more main engines 216 as coolant to chill-in the one or more main engines 216 or as a propellant to produce a landing burn.

The auxiliary fuel tank 224 may store a fuel type similar to that of the main fuel tank 218 including kerosene, alcohol, hydrazine, liquified methane, liquified natural gas, and/or liquified hydrogen. In some embodiments, the auxiliary fuel tank 224 may store the same fuel type as in the main fuel tank 218. In other embodiments, the auxiliary fuel tank 224 may store a different fuel type than that of the main fuel tank 218.

In some embodiments, the auxiliary fuel tank 224 may be located within the main fuel tank 218. The auxiliary fuel tank 224 may be mounted on a support 240 within the main fuel tank. The support 240 may include a post 242 extending forward from the aft end of the main fuel tank 218 to the aft end of the auxiliary fuel tank 224. In some embodiments, the post 242 may include and/or be integrated with a downcomer, pipe, conduit, or other device configured to fluidly connect the auxiliary fuel tank 224 to the one or more downcomers 238. In some embodiments, the support 240 may further include one or more fuel nozzles 244 configured to extend from the post 242 to one or more combustion chambers. The one or more fuel nozzles 244 may be fluidly connected to the auxiliary fuel tank 224 and one or more combustion chambers. The auxiliary fuel tank 224, and/or its support 240, may be mounted to the aft dome/wall located at the aft end of the main fuel tank 218, which may be designed to carry thrust loads. The auxiliary fuel tank 224 may be located within the main fuel tank 218 at other locations. In some embodiments, the auxiliary fuel tank 224 is not exposed to a free-stream during flight, e.g., during the ascent, of the reusable launch vehicle 200.

The auxiliary fuel tank 224 may comprise additional and/or alternative insulation 225 as compared to the main fuel tank 218. The insulation 225 may cover all or substantially all or a majority of an outer structural body that forms the auxiliary fuel tank 224. The auxiliary fuel tank 224 may have insulation 225 comprising a spray-on foam, a fenced vapor barrier, and/or blocks of an open-or closed-cell foam insulation to further thermally insulate the additional cryogenic fuel. The placement of the auxiliary fuel tank 224 within the main fuel tank 218 advantageously allows for insulation 225 that would otherwise be unusable during launch because the insulation 225 is sheltered from the free-stream. Some embodiments of such insulation 225, such as a spray-on foam or light-weight multi-layer insulation, which would not survive reentry in traditional launch vehicles. Multi-layer insulation may be made from thin layers of a highly reflective material such as aluminized polyimide separated by separating spacers or layers. The auxiliary fuel tank may incorporate a thermodynamic vent system that intercepts heat that would otherwise enter the tank and cause boil-off and transfer it to a working fluid, such as hydrogen, that absorbs heat through its heat of vaporization, specific heat capacity, and/or quantum effects such as para-ortho conversion. Para-ortho conversion in particular may be aided by a catalyst. This working fluid can then be vented overboard to provide propulsive thrust or vented non-propulsively, it may be burned or reacted to provide additional heat or electrical power or it may be used to cool other higher-temperature devices such as cryogenic oxidizer or electrical components. Thus, the auxiliary fuel tank 224 may be shielded from a free-stream and may benefit from the insulation 219 of the main fuel tank 218 and the insulation 225 of the auxiliary fuel tank 224. Accordingly, the auxiliary fuel tank 224 may be sufficiently thermally insulated to maintain the temperature and pressure of the auxiliary cryogenic fuel stored within the auxiliary fuel tank 224 for the duration of the mission.

The auxiliary oxidizer tank 226 may be located in a position forward of the main oxidizer tank 220. The auxiliary oxidizer tank 226 may be supported by a support structure 248. The support structure 248 may be annular with a lower rim 250 connected to an upper rim 252 via a plurality of ribs 254. The support structure 248 may be disposed on the forward end of the main oxidizer tank 220. The auxiliary oxidizer tank 226 is configured to store additional and auxiliary oxidizer fluidly separate from the main oxidizer tank 220. Additionally, the auxiliary oxidizer tank 226 may be coupled to and in fluid communication with one or more downcomers 238. The auxiliary oxidizer tank 226 may be configured for providing auxiliary oxidizer to one or more systems, including: a heat exchanger for converting the cryogenic oxidizer into a gaseous form to power a secondary device; one or more fuel cells such as hydrogen-oxygen fuel cells for generating electrical power; and/or one or more reentry reaction control system thrusters, orbital reaction control thrusters, the orbital maneuvering system engine 222, and landing engines for providing ascent circularization, settling, on-orbit maneuvering, attitude control, deorbit, and landing by providing the auxiliary fuel to said systems. In some embodiments, the auxiliary oxidizer tank 226 may not be configured to provide the additional oxidizer to the one or more main engines 216 for producing the main ascent burn. Instead, in some embodiments, the auxiliary oxidizer may be exclusively used for non-ascent burn purposes. For instance, the auxiliary oxidizer tank 226 may be physically coupled to and in fluid communication with one or more downcomers 238 for providing the auxiliary oxidizer to the one or more main engines 216 as coolant to chill-in the one or more main engines 216 or for providing the auxiliary oxidizer to the one or more main engines 216 as a propellant for producing a landing burn.

The auxiliary oxidizer tank 226 may be contained within the rocket body 202 of the reusable launch vehicle 200. The auxiliary oxidizer tank 226 may be located outside of the main oxidizer tank 220. The auxiliary oxidizer tank 226 may be located in the volume between the forward dome of the main oxidizer tank 220 and the payload adapter 212. The auxiliary oxidizer tank 226 may be separated from the main fuel tank 218 and the main oxidizer tank 220. Positioning the auxiliary oxidizer tank 226 forward, for example in the volume between the forward dome of the main oxidizer tank 220 and the payload adapter 212, provides several advantages, including: locating the center-of-mass slightly forward thereby reducing the aerosurface mass to trim during entry, descent, and landing; shortening the main oxidizer barrel section; consuming otherwise under-utilized volume; and making the auxiliary oxidizer tank 226 easier to service and insulate with launch-incompatible insulation 227. Moreover, locating the auxiliary oxidizer tank 226 within the rocket body 202 is advantageous because the auxiliary oxidizer tank 226 is then shielded from a free-stream and may benefit from the insulation 203 of the rocket body 202 and the insulation 227 of the auxiliary oxidizer tank 226.

The insulation 227 may cover all or substantially all or a majority of an outer structural body that forms the auxiliary oxidizer tank 226. The insulation 227 may comprise a spray-on foam, a fenced vapor barrier, and/or blocks of an open- or closed-cell foam insulation to further thermally insulate the additional cryogenic fuel. Some embodiments of such insulation 227, such as a spray-on foam or light-weight multi-layer insulation, would not survive reentry in traditional launch vehicles. Multi-layer insulation may be made from thin layers of a highly reflective material such as aluminized polyimide separated by separating spacers or layers. Accordingly, the auxiliary oxidizer tank 226 may be sufficiently thermally insulated to maintain the temperature and pressure of the auxiliary cryogenic oxidizer stored within the auxiliary oxidizer tank 226 for the duration of the mission. The insulation 227 of the auxiliary oxidizer tank 226 may have the same features as the insulation 225 described herein for the auxiliary fuel tank 224. Any of the insulated tanks described herein may include any or all features of the above listed insulation, including the insulation 219 for the main fuel tank 218, the insulation 221 for the main oxidizer tank 220, the insulation 225 for the auxiliary fuel tank 224, and the insulation 227 for the auxiliary oxidizer tank 226.

Implementing the auxiliary fuel tank 224 and the auxiliary oxidizer tank 226 as described herein provides several advantages over traditional single-tank launch vehicles. Existing launch vehicles attempt to minimize boil-off by providing multi-layer insulation for the liquified oxidizer and thermodynamic vent systems for liquified fuel. These solutions are impractical and mass prohibitive to use on mostly empty main tanks. In embodiments according to the present disclosure, the auxiliary fuel tank 224 and/or the auxiliary oxidizer tank 226 may be configured to intercept heat that leaks into the main fuel tank 218 and/or the main oxidizer tank 220 to maintain the cryogenic properties of the main fuel and/or main oxidizer. In some embodiments, the auxiliary fuel tank 224 and auxiliary oxidizer tank 226 may define a refrigeration cycle comprising a plurality of tubes interacting with the main fuel tank 218 and/or the main oxidizer tank 220, where the auxiliary fuel and/or auxiliary oxidizer flow through the plurality of tubes exchanging heat between the main tanks and the auxiliary tanks.

The auxiliary fuel tank 224 and auxiliary oxidizer tank 226 may form a single set of auxiliary tanks for storing all auxiliary propellants. As described in greater detail below, the auxiliary fuel tank 224 and the auxiliary oxidizer tank 226 may be in fluid communication with various auxiliary systems including an orbital maneuvering system, an orbital reaction control system, a reentry reaction control system, and/or a power generation system. In some embodiments, the auxiliary fuel tank 224 and auxiliary oxidizer tank 226 may each feed one or more of the various auxiliary systems based on mission-specific needs. Accordingly, the auxiliary fuel and auxiliary oxidizer stored within the single set of auxiliary tanks may be dynamically allocated or distributed among various systems and used for providing propulsion, e.g., for settling, on-orbit maneuvering, attitude control, deorbit, and/or landing, as well as for providing power generation. Thus, the single set of auxiliary tanks may advantageously provide increased efficiency and performance compared to traditional rockets designed with less integrated systems that require each system to be sized for its worst case

The one or more fins 228 may extend laterally from the rocket body 202. The one or more fins 228 may further comprise one or more volumes 256 (see FIG. 2B) defined by a cavity within the one or more fins 228. In some embodiments, the volume 256 may be configured to comprise the auxiliary fuel tank 224 or portions thereof.

The one or more downcomers 238 may be a hollow body, such as a pipe or conduit, comprising one or more elongated walls defining a cavity, for transporting cryogenic fluids. In some embodiments, the one or more downcomers 238 may couple to and be located between the main fuel tank 218 and the auxiliary fuel tank 224. Similarly, in some embodiments, the one or more downcomers 238 may couple to and be located between the main oxidizer tank 220 and the auxiliary oxidizer tank 226. In some embodiments, the one or more downcomers 238 may further couple to the one or more main engines 216, the orbital maneuvering system engine 222, and/or other systems requiring access to the cryogenic fluids. In some embodiments, one or more downcomers 238 may be integrated into the support 240. In some embodiments, the one or more downcomers 238 may be in fluid communication with the post 242, the one or more fuel nozzles 244, and/or the one or more oxidizer nozzles 246. In some embodiments, the one or more fuel nozzles 244 and/or the one or more oxidizer nozzles 246 may be in fluid communication with the one or more main engines 216, the orbital maneuvering system engine 222, and/or other systems requiring access to the cryogenic fluids. In some embodiments, valves may be fluidly connected to the one or more downcomers 238 and fluidly positioned between the tanks storing the cryogenic fluids and the one or more main engines 216, the orbital maneuvering system engine 222, and other systems requiring access to the cryogenic fluids. The valves may be independently activated for selectively providing cryogenic fluids to desired systems and components. Furthermore, additional valves may be fluidly connected to the one or more downcomers 238 and fluidly positioned between corresponding main and auxiliary tanks. For example, in some embodiments, valves may be fluidly connected between the main and auxiliary fuel tanks 218, 224 and/or between the main and auxiliary oxidizer tanks 220, 226.

FIG. 2C illustrates an alternative embodiment where the main fuel tank 218 may be fully integrated within the rocket body 202 extending from the aft end 204 to the payload adapter 212. The embodiment of FIG. 2C may be the same as FIG. 2A except as shown and noted below. As shown, the main oxidizer tank 220 may be located at or near the aft end 204 within the rocket body 202. The main oxidizer tank 220 may be located within the main fuel tank 218. For example, the main oxidizer tank 220 may be positioned between the aft end of the main fuel tank 218 and the aft end of the auxiliary fuel tank 224, such that the main oxidizer tank 220 is within the main fuel tank 218 near the aft end with the auxiliary fuel tank 224, and the auxiliary fuel tank 224 is located forward relative to the main oxidizer tank 220. Positioning the main oxidizer tank 220 near the aft end of the rocket body 202, provides several advantages, including insulating the main oxidizer tank 220 with launch-incompatible insulation 221. In some embodiments, the auxiliary fuel tank 224 may rest on the support structure 248 positioned above the main oxidizer tank 220. The auxiliary fuel tank 226 may rest on the support structure 248 positioned above the payload adapter 212.

The downcomers 238 may extend between the one or more fuel nozzles 244 and the auxiliary fuel tank 224, between the one or more oxidizer nozzles 246 and the main oxidizer tank 220, and/or between the one or more oxidizer nozzles 246 and the auxiliary oxidizer tank 226. The downcomer 238 fluidly connecting the auxiliary fuel tank 224 to the one or more fuel nozzles 244 may extend through and/or around the main oxidizer tank 220. Similarly, the downcomer 238 fluidly connecting the auxiliary oxidizer tank 224 to the one or more oxidizer nozzles 246 may extend through and/or around the main oxidizer tank 220. The configuration and general arrangement of the tanks may advantageously enable the balancing of the center-of-mass of the vehicle throughout the mission, where positioning a main oxidizer tank 220 aft of the main fuel tank 218 shifts the center-of-mass of the reusable launch vehicle 200 further aft and may reduce the overall mass of the reusable launch vehicle 200 by reducing the structural loads carried through the walls of the main fuel tank 218.

In some embodiments, the auxiliary oxidizer tank 226 can be located aft of the main oxidizer tank 220, the auxiliary oxidizer tank 226 can be located within the main oxidizer tank 220, the auxiliary oxidizer tank 226 can be located aft of the main fuel tank 218, and/or the main oxidizer tank 220 can be located aft of the main fuel tank 218, as described in further detail herein.

FIGS. 2D-2L illustrate various additional embodiments of the launch vehicle 200 having various positions for the main fuel tank 218, the main oxidizer tank 220, the auxiliary fuel tank 224, and the auxiliary oxidizer tank 226. The tanks may have a variety of specific positions relative to each other. Some specific configurations are shown in and described with respect to FIGS. 2D-2L. The embodiments of the launch vehicle 200 of FIGS. 2D-2L may have the same or similar features and/or functions as the launch vehicle 200 of FIGS. 2A and/or 2C, and vice versa, except as otherwise described and shown. Further, there may be one or more additional downcomers as required based on the various positions of the tanks and as shown in the figures.

FIG. 2D illustrates the launch vehicle 200 similar to that of FIG. 2A but with the auxiliary oxidizer tank 226 positioned within the main oxidizer tank 220. The auxiliary oxidizer tank 226 may be supported by the support structure 248 on a forward end of the support structure 248. The support structure 248 may be located within the main oxidizer tank 220. The auxiliary oxidizer tank 226 may be supported in an aft, central or forward location of an interior of the main oxidizer tank 220. The main oxidizer tank 220 with the auxiliary oxidizer tank 226 therein may be located entirely within the aft chamber 208. The main oxidizer tank 220 with the auxiliary oxidizer tank 226 therein may be located aft of the payload adaptor 212.

FIG. 2E illustrates the launch vehicle 200 similar to that of FIG. 2A but with the auxiliary oxidizer tank 226 positioned aft of the main oxidizer tank 220. The support structure 248 may be connected at a forward end to the main oxidizer tank 220 and at an aft end to the auxiliary oxidizer tank 226. As shown, the support structure 248 may be flipped in vertical orientation relative that shown in FIG. 2A, or the support structure 248 may have the same vertical orientation as that shown in FIG. 2A. The auxiliary oxidizer tank 226 may be located forward of the main fuel tank 218. In some embodiments, the forward end of the main fuel tank 218 may surround the auxiliary oxidizer tank 226 and/or an aft portion of the main oxidizer tank 220 for more efficient utilization of the interior space of the rocket body 110.

FIG. 2F illustrates the launch vehicle 200 similar to that of FIG. 2E but with the auxiliary fuel tank 224 positioned forward of the main oxidizer tank 220. There may be two of the support structures 248. The auxiliary fuel tank 224 may be supported by one of the support structures 248. The support structures 248 may have reverse vertical orientations relative to each other. One or more of the downcomers may extend from the auxiliary fuel tank 224 either through or around the main oxidizer tank 220.

FIG. 2G illustrates a launch vehicle 200 similar to that of FIG. 2F but with the auxiliary oxidizer tank 226 positioned within the main oxidizer tank 220. There may be two of the support structures 248. The auxiliary oxidizer tank 226 may be supported within the main oxidizer tank 220 by one of the support structures 248, for example as described with respect to FIG. 2D.

FIG. 2H illustrates a launch vehicle 200 similar to that of FIG. 2C but with the auxiliary fuel tank 224 positioned forward of the main fuel tank 218. The auxiliary oxidizer tank 226 may be positioned forward of the main oxidizer tank 220. There may be two of the support structures 248. The auxiliary oxidizer tank 226 may be supported by one of the support structures 248. The auxiliary oxidizer tank 226 may be positioned aft of the main fuel tank 218. The auxiliary oxidizer tank 226 may be positioned between the main fuel tank 218 and the main oxidizer tank 220. As shown, the main fuel tank 218 may be positioned entirely forward of the auxiliary oxidizer tank 226. In some embodiments, an aft portion of the main fuel tank 218 may surround the auxiliary oxidizer tank 226 and/or a forward portion of the main oxidizer tank 220 for efficient utilization of volume within the rocket body 110.

FIG. 2I illustrates a launch vehicle 200 similar to that of FIG. 2H but with the auxiliary oxidizer tank 226 positioned within the main oxidizer tank 220. There may be two of the support structures 248. The auxiliary oxidizer tank 226 may be supported by one of the support structures 248 within the main oxidizer tank 220, for example as described with respect to FIG. 2D.

FIG. 2J illustrates a launch vehicle 200 similar to that of FIG. 2C but with the auxiliary oxidizer tank 226 positioned within the main oxidizer tank 220. There may be two of the support structures 248. The auxiliary oxidizer tank 226 may be supported by one of the support structures 248 within the main oxidizer tank 220, for example as described with respect to FIG. 2D.

FIG. 2K illustrates a launch vehicle 200 similar to that of FIG. 2F but with the main oxidizer tank 220 and the auxiliary oxidizer tank 226 positioned aft of the main fuel tank 218. The main fuel tank 218 may surround a forward portion of the main oxidizer tank 220 for efficient utilization of volume within the rocket body 110. In some embodiments, the main fuel tank 218 may be located entirely forward of the main oxidizer tank 220.

FIG. 2L illustrates a launch vehicle 200 similar to that of FIG. 2K but with the auxiliary fuel tank 224 attached to a forward end of the main oxidizer tank 220. An aft end of the main fuel tank 218 may surround the auxiliary fuel tank 224 and a forward portion of the main oxidizer tank 220. In some embodiments, the auxiliary fuel tank 224 may be located within the main fuel tank 218 and attached to an aft end of the interior of the main fuel tank 218. In some embodiments, the main fuel tank 218 may be located entirely forward of the main oxidizer tank 220 and/or the auxiliary fuel tank 224.

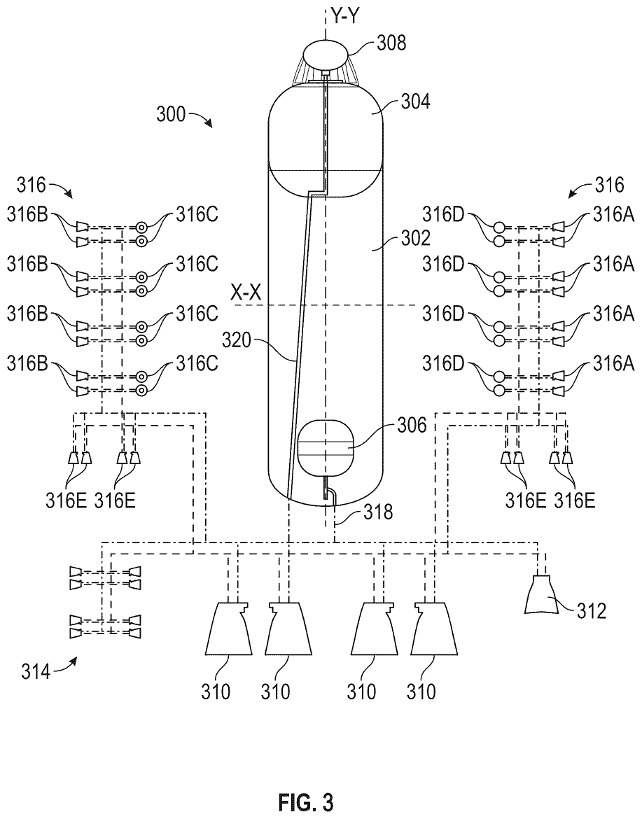

FIG. 3 is a schematic illustrating an embodiment of a fluid system 300 for transporting fluids to components comprised within a launch vehicle. In some embodiments, the launch vehicle using the system 300 may be the same as the any of the reusable launch vehicles 200 or upper stage 104 discussed herein, such as those shown in and described with respect to FIGS. 1-2L. The fluid system 300 may comprise a main fuel tank 302, a main oxidizer tank 304, an auxiliary fuel tank 306, an auxiliary oxidizer tank 308, a plurality of main engines 310, an orbital maneuvering system engine 312, a reentry reaction control system 314, an orbital reaction control system 316, a fuel downcomer 318, and/or an oxidizer downcomer 320.

Several components comprised within the fluid system 300 may be the same as those in the reusable launch vehicles 200 described above. These components include the physical components including the main fuel tank 302, the main oxidizer tank 304, the auxiliary fuel tank 306, the auxiliary oxidizer tank 308, the plurality of main engines 310, and the orbital maneuvering system engine 312, which may be the same or similar as the main fuel tank 218, the main oxidizer tank 220, the auxiliary fuel tank 224, the auxiliary oxidizer tank 226, the plurality of main engines 216, and the orbital maneuvering system engine 222, respectively.

The reentry reaction control system 314 may comprise a plurality of thrusters 314A-314D located around the body of the launch vehicle and oriented in varying directions for turning and orienting the launch vehicle during reentry and landing. The reentry reaction control system 314 may be configured to control the attitude or orientation of the launch vehicle. The plurality of thrusters 314A-314D may be in fluid communication with the auxiliary fuel tank 306 and the auxiliary oxidizer tank 308 via the downcomers 318, 320 for providing propulsion.

The orbital reaction control system 316 may comprise a plurality of thrusters 316A-316E located around the body of the launch vehicle and oriented in varying directions for turning and orienting the launch vehicle in micro-gravity. In some embodiments, the orbital reaction control system 316 may comprise four, eight, twelve, sixteen, twenty, twenty-four, or more individual thrusters 316A-316E oriented about the launch vehicle. The plurality of thrusters 316A-316D may be configured to provide 3-axis attitude control while the plurality of thrusters 316E may be configured to provide an axial acceleration, e.g., for propellant settling. In some embodiments, the plurality of thrusters 316A-316E may be positioned about the aft end of the launch vehicle to protect sensitive payloads from damage or contamination that may be present in forward-located thrusters 316A-316E. The plurality of thrusters 316A-316E may be in fluid communication with the auxiliary fuel tank 306 and the auxiliary oxidizer tank 308 via the downcomers 318, 320 for providing propulsion.

The respective positions and orientations of the thrusters 316A-316E may be described with relation to their respective vectors compared to the midline. The one or more thrusters 316A may be located on a first side of the launch vehicle and laterally oriented for providing thrust away from the midline, thereby causing the launch vehicle to move in a fist direction. The one or more thrusters 316B may be located on a second side of the launch vehicle opposite the first side and laterally oriented for providing thrust away from the midline, thereby causing the launch vehicle to move in a second direction opposite the first direction. In some embodiments, the first side may correspond to the right side and the second side may correspond to the left side. In other embodiments, the first side may correspond to the left side and the second side may correspond to the right side. The one or more thrusters 316C may be located on a third side of the launch vehicle and laterally oriented for providing thrust away from the midline thereby causing the launch vehicle to move in a third direction. The one or more thrusters 316D may be located on a fourth side of the launch vehicle opposite the third side and laterally oriented for providing thrust away from the midline thereby causing the launch vehicle to move in a fourth direction opposite the third direction.

In some embodiments, the one or more thrusters 316A-316D may be linearly positioned along a vertical center line of their respective sides of the launch vehicle, for example, the Y-Y axis. In other embodiments, the one or more thrusters 316A-316D may be positioned on either side of a vertical center line of their respective sides of the launch vehicle. In such embodiments, the one or more thrusters 316A-316B may be activated simultaneously to push the launch vehicle laterally along the X-X axis. Similarly, the one or more thrusters 316C-316D may be activated simultaneously to push the launch vehicle laterally along the Z-Z axis oriented orthogonally to both the Y-Y and X-X axes. Any combination of activation may be possible to move the launch vehicle about the X-Z plane. Alternatively, one or more thrusters 316A-316D may be selectively activated such that thrusters 316A-316D positioned on one side of the vertical center lines of their respective sides are activated, thereby providing torque to the launch vehicle rendering a rotational motion about the Y-Y axis. Furthermore, the one or more thrusters 316A-316D may be activated based on their vertical placement. In some embodiments, the one or more thrusters 316A-316D may be selectively activated to rotate the launch vehicle about an X-X or Z-Z axes. Accordingly, the one or more thrusters 316A-316D may be configured to provide 3-axis attitude control.

By comparison, the one or more thrusters 316E may be located on the aft side of the launch vehicle and oriented orthogonal to the plurality of thrusters 316A-316D. In some embodiments, activating the one or more thrusters 316E provides axial acceleration along the Y-Y axis to provide forward motion of the launch vehicle for propellant settling.

The fuel downcomer 318 may physically extend between and couple to the main fuel tank 302, the auxiliary fuel tank 306, the plurality of main engines 310, the orbital maneuvering system engine 312, the thrusters of the reentry reaction control system 314, and/or the plurality of thrusters 316A-316E of the orbital reaction control system 316. The fuel downcomer 318 may further be in fluid communication with one or more of the aforementioned components and configured to provide fuel to the respective engines and/or thrusters. The fuel downcomer 318 may be configured to provide fuel from the main fuel tank 302 exclusively to the plurality of main engines 310. The fuel downcomer 318 may be further configured to provide fuel from the auxiliary fuel tank 306 exclusively to one or more of the auxiliary systems, including the orbital maneuvering system engine 312, the reentry reaction control system 314, and the orbital reaction control system 316.

Similarly, the oxidizer downcomer 320 may physically extend between and couple to the main oxidizer tank 304, the auxiliary oxidizer tank 308, the plurality of main engines 310, the orbital maneuvering system engine 312, the thrusters of the reentry reaction control system 314, and/or the plurality of thrusters 316A-316E of the orbital reaction control system 316. The oxidizer downcomer 320 may further be in fluid communication with the aforementioned components and configured to provide an oxidizer, such as liquid oxygen, to the respective engines and/or thrusters. The oxidizer downcomer 320 may be configured to provide liquid oxygen from the main fuel tank 302 exclusively to the plurality of main engines 310. Similarly, the oxidizer downcomer 320 may be configured to provide liquid oxygen from the auxiliary oxidizer tank 308 exclusively to the auxiliary systems including the orbital maneuvering system engine 312, the reentry reaction control system 314, and the orbital reaction control system 316.

The downcomers 318, 320 may be coupled to a plurality of valves fluidly positioned between the tanks storing cryogenic fluids and the one or more engines 310, 312 and/or thrusters 314A-314D, 316A-316D. In some embodiments, each engine 310, 312 and/or thruster 314A-316D, 316A-316D may be fluidly connected to two valves wherein a first valve may be in fluid communication with the fuel downcomer 318 and a second valve may be in fluid communication with the oxidizer downcomer 320. Furthermore, each valve may be in electrical or computational communication with an onboard computer or controller, such as a navigation system, for selectively activating valves to activate one or more desired engines or thrusters for applying a force on the launch vehicle.

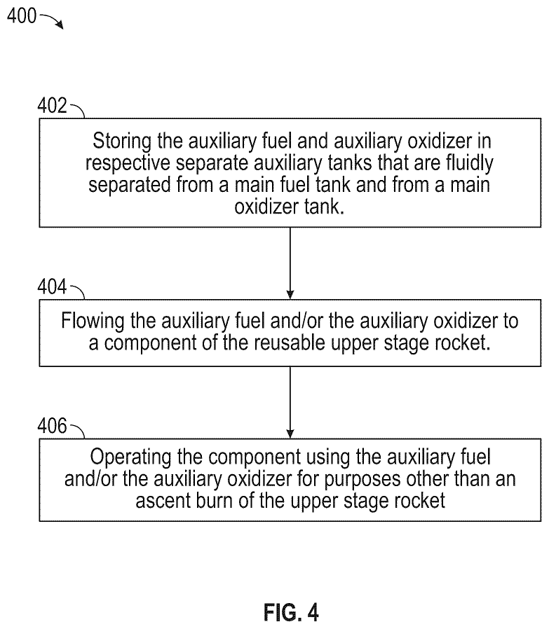

FIG. 4 is a flow chart illustrating an embodiment of a method 400 of using auxiliary tanks of a launch vehicle, such as a reusable upper stage rocket, for non-ascent purposes, such as performing an orbital injection after the main engines are cutoff, orbital corrections during flight, and final deorbit burn for reentry. Additionally or alternatively, the auxiliary tanks may be used for any maneuver with the reusable upper stage rocket such as reorienting the attitude of the reusable upper stage rocket, or landing the reusable upper stage rocket. The method 400 may be used to supply auxiliary fuel and auxiliary oxidizer to a reusable upper stage rocket for non-ascent purposes.

The method begins with step 402 where the auxiliary fuel and auxiliary oxidizer is stored in respective separate auxiliary tanks that are fluidly separate from a main fuel tank and from a main oxidizer tank. In such embodiments, the launch vehicle may comprise two distinct fuel tanks (one main and one auxiliary) and two distinct oxidizer tanks (one main and one auxiliary). Step 402 may occur prior to launch wherein the tanks of the launch vehicle are filled. Any of the configurations described with respect to FIGS. 2A-3 may be used for the tanks in step 402.

The method then moves to step 404 where the auxiliary fuel and/or the auxiliary oxidizer flow, or are caused to flow, to one or more components of the reusable upper stage rocket. In some embodiments, the auxiliary fuel and auxiliary oxidizer simultaneously flow, or are caused to flow, to a component of the reusable upper stage rocket such that the component may burn both the oxidizer and fuel simultaneously. In some embodiments, the reusable upper stage rocket may comprise a plurality of components including the main engines, the orbital maneuvering system, the reentry reaction control system, and the orbital reaction control system. In some embodiments, the auxiliary fuel and auxiliary oxidizer may be configured to flow to one component at a time. In other embodiments, the auxiliary fuel and auxiliary oxidizer may flow, or be caused to flow, to multiple components simultaneously. Any of the configurations or uses of the auxiliary propellants described with respect to FIGS. 2A-3 may be incorporated in step 404 for the tanks, components, downcomers, etc.

The method then moves to step 406 where the component is operated using the auxiliary fuel and/or the auxiliary oxidizer for purposes other than an ascent burn of the upper stage rocket. For example, the component may produce an orbital maneuver burn, a reorientation burn, or a landing burn. Additionally or alternatively, the component may use the auxiliary fuel and/or the auxiliary oxidizer to reorient the attitude of the reusable upper stage rocket, or land the reusable upper stage rocket. Any of the configurations or uses of the auxiliary propellants described with respect to FIGS. 2A-3 may be incorporated in step 406 for the tanks, components, downcomers, etc.

The foregoing description details certain embodiments of the systems, devices, and methods disclosed herein. It will be appreciated, however, that no matter how detailed the foregoing appears in text, the systems, devices, and methods can be practiced in many ways. It should be noted that the use of particular terminology when describing certain features or aspects of the disclosure should not be taken to imply that the terminology is being re-defined herein to be restricted to including any specific characteristics of the features or aspects of the technology with which that terminology is associated.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the figures may be combined, interchanged or excluded from other embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The term “comprising” as used herein is synonymous with “including,” “containing,” or “characterized by,” and is inclusive or open-ended and does not exclude additional, unrecited elements or method steps.

It is noted that some examples above may be described as a process, which is depicted as a flowchart, a flow diagram, a structure diagram, or a block diagram. Although a flowchart may describe the operations as a sequential process, many of the operations can be performed in parallel, or concurrently, and the process can be repeated. In addition, the order of the operations may be rearranged. A process is terminated when its operations are completed. A process may correspond to a method, a function, a procedure, a subroutine, a subprogram, etc. When a process corresponds to a software function, its termination corresponds to a return of the function to the calling function or the main function.

The above description discloses several methods and materials of the present disclosure. This disclosure is susceptible to modifications in the methods and materials, as well as alterations in the fabrication methods and equipment. Such modifications will become apparent to those skilled in the art from a consideration of this disclosure or practice of the embodiments disclosed herein. Consequently, it is not intended that this disclosure be limited to the specific embodiments disclosed herein, but that it cover all modifications and alternatives coming within the true scope and spirit of the disclosure as embodied in the attached claims.

What is claimed is:

1. A reusable upper stage rocket comprising:
a rocket body extending from an aft end to a forward end, the forward end comprising a payload and the aft end comprising a main engine;
a main fuel tank located within the rocket body and storing liquid hydrogen;
a main oxidizer tank located within the rocket body and storing liquid oxygen, wherein the main fuel tank and the main oxidizer tank are in fluid communication with the main engine and are configured to provide the respective liquid hydrogen and liquid oxygen to the main engine to produce a main ascent burn;
an auxiliary fuel tank located within the rocket body and storing additional liquid hydrogen, the auxiliary fuel tank fluidly separated from the main fuel tank and the main oxidizer tank and comprising insulation configured to thermally insulate the additional liquid hydrogen; and
an auxiliary oxidizer tank located within the rocket body and storing additional liquid oxygen, the auxiliary oxidizer tank fluidly separated from the main fuel tank and the main oxidizer tank and comprising insulation configured to thermally insulate the additional liquid oxygen, wherein the auxiliary fuel tank and the auxiliary oxidizer tank are not configured to provide the respective additional liquid hydrogen and additional liquid oxygen to the main engine to produce the main ascent burn.

2. The rocket of claim 1, wherein the auxiliary fuel tank and the auxiliary oxidizer tank are not exposed to a free-stream during ascent of the rocket.

3. The rocket of claim 1, further comprising an orbital maneuvering system engine, wherein the auxiliary fuel tank and the auxiliary oxidizer tank are in fluid communication with the orbital maneuvering system engine and are configured to provide the respective additional liquid hydrogen and additional liquid oxygen to the orbital maneuvering system engine to produce an orbital maneuver burn.

4. The rocket of claim 1, further comprising a reaction control system thruster, wherein the auxiliary fuel tank and the auxiliary oxidizer tank are in fluid communication with the reaction control system thruster and are configured to provide the respective additional liquid hydrogen and additional liquid oxygen to the reaction control system thruster to produce a reorientation burn.

5. The rocket of claim 1, wherein the auxiliary fuel tank and the auxiliary oxidizer tank are in fluid communication with the main engine and are configured to provide the respective additional liquid hydrogen and additional liquid oxygen to the main engine to produce a landing burn.

6. The rocket of claim 1, wherein the auxiliary fuel tank and the auxiliary oxidizer tank are in fluid communication with the main engine and are configured to provide the respective additional liquid hydrogen or additional liquid oxygen to the main engine as coolant to chill-in the main engine.

7. The rocket of claim 1, wherein the auxiliary fuel tank or the auxiliary oxidizer tank are configured to insulate from heat that leaks into the main oxidizer tank or the main fuel tank to maintain the liquid oxygen or liquid hydrogen respectively at cryogenic temperatures.

8. The rocket of claim 1, further comprising hydrogen-oxygen fuel cells, and wherein the auxiliary fuel tank and the auxiliary oxidizer tank are in fluid communication with the hydrogen-oxygen fuel cells and are configured to provide the respective additional liquid hydrogen or additional liquid oxygen as reactants in the hydrogen-oxygen fuel cells for generating electrical power.

9. The rocket of claim 1, further comprising a heat exchanger, and wherein the auxiliary fuel tank and the auxiliary oxidizer tank are in fluid communication with the heat exchanger, the heat exchanger configured to convert the additional liquid hydrogen or additional liquid oxygen into gaseous form to drive a secondary device.

10. The rocket of claim 9, wherein the secondary device comprises one or more of a valve, a turbine, a rotating device, or a pneumatic device.

11. The rocket of claim 1, wherein the auxiliary fuel tank and the auxiliary oxidizer tank allocate fuel and oxidizer dynamically between auxiliary systems.

12. The rocket of claim 1, further comprising an annular support structure disposed on a forward end of the main oxidizer tank and supporting the auxiliary oxidizer tank forward of the main oxidizer tank.

13. The rocket of claim 1, wherein the main oxidizer tank is positioned at the aft end of the rocket body between the aft end of the rocket body and the aft end of the main fuel tank.

14. The rocket of claim 1, wherein the auxiliary oxidizer tank is forward of and supported by the main fuel tank.

15. The rocket of claim 1, wherein the auxiliary fuel tank is forward of and supported by the main oxidizer tank.

16. The rocket of claim 1, wherein the main oxidizer tank is forward of the main fuel tank.

17. The rocket of claim 16, wherein the auxiliary oxidizer tank is forward of and supported by the main oxidizer tank.

18. A launch vehicle comprising:
a reusable first stage rocket; and
a reusable upper stage rocket supported forward of the reusable first stage rocket, the reusable upper stage rocket comprising:
a rocket body extending from an aft end to a forward end, the forward end having a payload and the aft end comprising a main engine;
a main fuel tank located within the rocket body and storing liquid hydrogen;
a main oxidizer tank located within the rocket body and storing liquid oxygen, wherein the main fuel tank and the main oxidizer tank are in fluid communication with the main engine and are configured to provide the respective liquid hydrogen and liquid oxygen to the main engine to produce a main ascent burn;
an auxiliary fuel tank located within the rocket body and storing additional liquid hydrogen, the auxiliary fuel tank fluidly separated from the main fuel tank and the main oxidizer tank and comprising insulation configured to thermally insulate the additional liquid hydrogen; and
an auxiliary oxidizer tank located within the rocket body and storing additional liquid oxygen, the auxiliary oxidizer tank fluidly separated from the main fuel tank and the main oxidizer tank and comprising insulation configured to thermally insulate the additional liquid oxygen, wherein the auxiliary fuel tank and the auxiliary oxidizer tank are not configured to provide the respective additional liquid hydrogen and additional liquid oxygen to the main engine to produce the main ascent burn.

19. The launch vehicle of claim 18, wherein the auxiliary fuel tank and the auxiliary oxidizer tank are not exposed to a free-stream during ascent of the launch vehicle.

20. The launch vehicle of claim 18, wherein the reusable upper stage rocket further comprises an orbital maneuvering system engine, wherein the auxiliary fuel tank and the auxiliary oxidizer tank are in fluid communication with the orbital maneuvering system engine and are configured to provide the respective additional liquid hydrogen and additional liquid oxygen to the orbital maneuvering system engine to produce an orbital maneuver burn.

21. The launch vehicle of claim 18, wherein the reusable upper stage rocket further comprises a reaction control system thruster, wherein the auxiliary fuel tank and the auxiliary oxidizer tank are in fluid communication with the reaction control system thruster and are configured to provide the respective additional liquid hydrogen and additional liquid oxygen to the reaction control system thruster to produce a reorientation burn.

22. The launch vehicle of claim 18, wherein, in the reusable upper stage rocket, the auxiliary fuel tank and the auxiliary oxidizer tank are in fluid communication with the main engine and are configured to provide the respective additional liquid hydrogen and additional liquid oxygen to the main engine to produce a landing burn.

23. A method of supplying auxiliary fuel and auxiliary oxidizer to a reusable upper stage rocket for non-ascent purposes, the method comprising:
storing the auxiliary fuel and the auxiliary oxidizer in respective separate auxiliary tanks that are fluidly separated from a main fuel tank and from a main oxidizer tank;
causing a flow of the auxiliary fuel or the auxiliary oxidizer to a component of the reusable upper stage rocket; and
operating the component using the auxiliary fuel or the auxiliary oxidizer for a purpose other than an ascent burn of the upper stage rocket.

24. The method of claim 23, wherein operating the component comprises producing an orbital maneuver burn, producing a reorientation burn, or producing a landing burn.

25. The method of claim 23, further comprising performing an orbital maneuver with the reusable upper stage rocket, reorienting the attitude of the reusable upper stage rocket, or landing the reusable upper stage rocket.
